(19) United States
(12) Patent Application Publication
(10) Pub. No.: US 2011/0028637 A1
(43) Pub. Date: Feb. 3, 2011

(54) Method for Preparing Thermoplastic Vulcanizates

(76) Inventors: Maria Dolores Ellul, Silver Lake Village, OH (US); Hari Prasad Nadella, Copley, OH (US); Oscar Oansuk Chung, Houston, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 12/597,515

(22) Filed: Oct. 26, 2009

Related U.S. Application Data
(63) Continuation of application No. PCT/US2008/058641, filed on Mar. 28, 2008.
(60) Provisional application No. 60/927,012, filed on May 1, 2007.

(51) Int. Cl. C08L 55/00

(52) U.S. Cl. 524/554

(57) ABSTRACT

A method for preparing a thermoplastic vulcanizate, the method comprising introducing an elastomer and a thermoplastic resin to a reaction extruder, where the elastomer is not prepared by gas-phase polymerization methods, and where less than 75 parts by weight oil, per 100 parts by weight elastomer, is added to the extruder with the elastomer, introducing a curative to the extruder after said step of introducing an elastomer, introducing an oil to the extruder after said step of introducing an elastomer but before or together with said step of introducing a curative, and introducing an oil to the extruder after said step of introducing a curative.

### CROSS REFERENCE TO RELATED APPLICATIONS

This application claims priority benefit of Provisional Application No. 60/927,012 filed May 1, 2007, the disclosure of which is incorporated by reference in its entirety.

### FIELD OF INVENTION

This invention relates to a process for preparing thermoplastic vulcanizates (TPV) using introduction of process oil to control the quality of the TPV.

### BACKGROUND OF THE INVENTION

Thermoplastic elastomers have many of the properties of thermoset elastomers, yet they are processable as thermoplastics making both manufacturing scrap and final products capable of recycle uses. One type of thermoplastic elastomer is a thermoplastic vulcanizate, which may be characterized by finely-divided rubber particles dispersed within a plastic. These rubber particles are crosslinked to promote elasticity. Thermoplastic vulcanizates are conventionally produced by dynamic vulcanization, which is a process whereby a rubber is cured or vulcanized within a blend with at least one non-vulcanizing thermoplastic polymer while the polymers are undergoing mixing or masticating at an elevated temperature, above the melt temperature of the non-vulcanizing polymer.

Cross-linked, or vulcanized, rubber materials are well-known as are the processes for cross-linking, or vulcanizing, the rubber. Typically the vulcanizing is done with a molded rubber to allow adequate shaping to desired shape and dimensions, that is by static vulcanization. After cross-linking, or vulcanization, the molded rubber article or object is not thermoplastic, and is called thermoset, and cannot be melted or shaped in melted form. As is well-known, the cross-linking, or vulcanization, reaction involves using one or more curing agents that chemically reacts with two or more elastomeric chains to cross-link them, or causes two or more elastomeric polymer chains to cross-link chemically. This re-enforces elastomeric properties and inhibits polymer deformation by virtue of the energy absorbing character of the thermoset rubber, which occurs generally without the breaking of molecular or inter-polymer bonds that is more typical of non-elastomeric polymers. It is also well-known that the more cross-link sites present in the thermoset rubber, the greater its elastomeric properties.

It is additionally known that the molecular weight of the rubber, prior to cross-linking, affects the elastomeric properties, the higher the molecular weight, the greater the thermoset rubber elastic properties. However, it is also known that the higher the molecular weight of the rubber, prior to cross-linking or vulcanization, the more difficult it is to process or mix and convey in a polymer mixing device. Accordingly, it is common for rubber manufacturers to add process oil after the initial polymerization of the cross-linkable, but not cross-linked, rubber. Such rubber is commonly called an oil-extended rubber or elastomer product. However, this adds an extra step to manufacturing and leaves the choice of extender oil to the manufacturer, not the end user of the rubber. The manufacture of non-oil extended rubber of high molecular weight is possible but is either burdened by the need to add extender oil in later processing steps, or requires unusual processes of polymerization, e.g., gas phase polymerization of particulate rubber containing a filler, such as carbon black.

The use of high molecular weight, oil-extended rubber, in thermoplastic vulcanizates is well-known. For example, EP 0 930 337 B1 teaches a thermoplastic elastomer composition prepared by dynamically treating a polymer composition comprising (a) an oil-extended ethylene-based copolymer rubber which comprises an ethylene-based copolymer rubber with an intrinsic viscosity [η] in the range from 4.3 to 6.8 dl/g when measured at 135° C. in Decalin and mineral oil softening agent and (b) an olefin-based resin, with heat in the presence of a crosslinking agent.

The use of gas-phase rubber in thermoplastic vulcanizates is known, see for instance EP-B-0775 178. Dynamic vulcanization of these high molecular weight polymers are also known, see for example WO 03/059963, and U.S. Patent Publication Nos. 2004/0171758 A1 and 2006/0052538 A1. The latter describes the use of specific oil addition steps to enable optimal processing of the particulate filler containing rubber produced by gas-phase polymerization processes. However, it is not always acceptable to have particulate fillers like carbon black present in thermoplastic vulcanizates for end product characteristic reasons, particularly color.

Because the number of uses of thermoplastic vulcanizates is increasing, the performance demands that are placed on these materials are more demanding, and manufacturing efficiency of the materials is continually pursued, there exists a need to overcome some of the shortcomings associated with the prior methods of manufacture. More specifically, these performance demands make it important to achieve and control the final thermoplastic elastomer elastic properties.

### SUMMARY OF THE INVENTION

One or more embodiments of the present invention provide a method for preparing a thermoplastic vulcanizate, the method comprising introducing an elastomer and a thermoplastic resin to a reaction extruder, where the elastomer is not prepared by gas-phase polymerization methods, and where less than 75 parts by weight oil, per 100 parts by weight elastomer, is added to the extruder with the elastomer, introducing a curative to the extruder after said step of introducing an elastomer, introducing an oil to the extruder after said step of introducing an elastomer but before or together with said step of introducing a curative, and introducing an oil to the extruder after said step of introducing a curative.

### ILLUSTRATIVE EMBODIMENTS OF THE ILLUSTRATIVE EMBODIMENTS

### Introduction

The process for making thermoplastic vulcanizates according to one or more embodiments of the present invention includes adding process oil together with or before the addition of a curative and after the introduction of a curative within a reaction extruder. In these or other embodiments, dynamic vulcanization of the rubber occurs in the presence of a requisite amount of oil. In one or more embodiments, the introduction of oil before introduction of a curative unexpectedly improves the cure characteristics of a thermoplastic vulcanizate. In certain embodiments, the amount of oil added and the location of oil addition may be further tailored to achieve advantageous properties.

As is known in the art, thermoplastic vulcanizates can be prepared by dynamically vulcanizing an elastomer while the elastomer undergoes mixing and/or shearing with a thermoplastic resin.

### Ingredients:

### Elastomer

Any elastomer or mixture thereof that is capable of being crosslinked or cured, i.e., vulcanized, can be used as the elastomeric, or rubber, component. Reference to a rubber or elastomer may include mixtures of more than one. Useful elastomers typically contain some degree of unsaturation in their polymeric main chain. Some non-limiting examples of these rubbers include elastomeric polyolefin copolymer elastomers, butyl rubber, natural rubber, styrene-butadiene copolymer rubber, butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlolorohydrin terpolymer rubber, and polychloroprene.

In one or more embodiments, vulcanizable elastomers include polyolefin copolymer rubbers. Commonly available copolymer rubbers are those made from one or more of ethylene and higher α-olefins, which may include, but are not limited to, the preferred propylene, 1-butene, 1-hexene, 4-methyl-1 pentene, 1-octene, 1-decene, or combinations thereof, plus one or more copolymerizable, multiply unsaturated comonomer, such as diolefins, or diene monomers. In certain embodiments, the α-olefins are propylene, 1-hexene, 1-octene, or combinations thereof. These rubbers may lack substantial crystallinity and in many cases are suitably amorphous copolymers.

The diene monomers may include, but are not limited to, 5-ethylidene-2-norbornene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; 5-vinyl-2-norbornene, divinyl benzene, and the like, or a combination thereof. In preferred embodiments, the diene monomers are 5-ethylidene-2-norbornene and/or 5-vinyl-2-norbornene. In the event that the copolymer is prepared from ethylene, α-olefin, and diene monomers, the copolymer may be referred to as a terpolymer (EPDM rubber) or even a tetrapolymer in the event that multiple α-olefins or dienes, or both, are used (EAODM rubber). As used herein, the term “copolymer” shall mean polymers comprising two or more different monomers.

In one or more embodiments, polyolefin elastomeric copolymers contain from about 15 to about 90 mole percent ethylene units deriving from ethylene monomer, in other embodiments, from about 40 to about 85 mole percent, and in another embodiments, from about 50 to about 80 mole percent ethylene units. In one or more embodiments, the copolymer may contain from about 10 to about 85 mole percent, or from about 15 to about 50 mole percent, or from about 20 to about 40 mole percent, α-olefin units deriving from α-olefin monomers. The foregoing mole percentages are based upon the total moles of the mer units of the polymer. Where the copolymer contains diene units, the copolymers may contain from 0.1 to about 14 weight percent, in other embodiments from about 0.2 to about 13 weight percent, and in other embodiments from about 1 to about 12 weight percent units deriving from diene monomer. The weight percent diene units deriving from diene may be determined according to ASTM D-6047. In particular embodiments, the copolymers contain less than 5.5 weight percent, in other embodiments less than 5.0 weight percent, in other embodiments less than 4.5 weight percent, and in other embodiments less than 4.0 weight percent units deriving from diene monomer. In other embodiments, the copolymers contain greater than 6.0 weight percent, in other embodiments greater than 6.2 weight percent, in other embodiments greater than 6.5 weight percent, in other embodiments greater than 7.0 weight percent units, and in other embodiments greater than 8.0 weight percent deriving from diene monomer.

The catalyst employed to polymerize the ethylene, α-olefin, and diene monomers into elastomeric copolymers can include both traditional Ziegler-Natta type catalyst systems, especially those including titanium and vanadium compounds, as well as titanium, zirconium and hafnium mono- and biscyclopentadienyl metallocene catalysts. Other catalyst systems such as Brookhart catalyst system may also be employed.

In one embodiment, the polyolefinic elastomeric copolymers can have a weight average molecular weight (M_{w}) that is greater than about 150,000 g/mole, or from about 300,000 to about 850,000 g/mole, or from about 400,000 to about 700,000 g/mole, or from about 500,000 to about 650,000 g/mole. In these or other embodiments, the M_{w} is less than 700,000 g/mole, in other embodiments less than 600,000 g/mole, and in other embodiments less than 500,000 g/mole. These copolymers have a number average molecular weight (Mₙ) that is greater than about 50,000 g/mole, or from about 100,000 to about 350,000 g/mole, or from about 120,000 to about 300,000 g/mole, or from about 130,000 to about 250,000 g/mole. In these or other embodiments, the Mₙ is less than 300,000 g/mole, in other embodiments less than 225,000 g/mole, and in other embodiments less than 200,000 g/mole. Typically M_{w} and Mₙ can be characterized by GPC (gel permeation chromatography) in accordance with known methods.

In one embodiment, the elastomeric copolymers have a Mooney Viscosity (ML₁₊₄@125° C.) of from about 30 to about 300, or from about 50 to about 250, or from about 80 to about 200, where the Mooney Viscosity is that of the neat polymer. That is, for the purposes of the description and claims, the Mooney Viscosity is measured on non-oil extended rubber, or practically, from the reactor prior to oil extension.

As used herein, Mooney viscosity is reported using the format: Rotor ([pre-heat time, min.]+[shearing time, min.] @ measurement temperature, ° C.), such that ML (1+4@125° C.) indicates a Mooney viscosity determined using the ML or large rotor according to ASTM D1646-99, for a pre-heat time of 1 minute and a shear time of 4 minutes, at a temperature of 125° C.

Unless otherwise specified, Mooney viscosity is reported herein as ML(1+4@125° C.) in Mooney units according to ASTM D-1646. However, Mooney viscosity values greater than about 100 cannot generally be measured under these conditions. In this event, a higher temperature can be used (i.e., 150° C.), with eventual longer shearing time (i.e., 1+8@125° C. or 150° C.) In certain embodiments, the Mooney measurement for purposes herein is carried out using a non-standard small rotor. The non-standard rotor design is employed with a change in the Mooney scale that allows the same instrumentation on the Mooney instrument to be used with polymers having a Mooney viscosity over about 100 ML(1+4@125° C.). For purposes herein, this modified Mooney determination is referred to as MST—Mooney Small Thin. ASTM D1646-99 prescribes the dimensions of the rotor to be used within the cavity of the Mooney instrument. This method allows for both a large and a small rotor, differing only in diameter. These different rotors are referred to in ASTM D1646-99 as ML (Mooney Large) and MS (Mooney Small). However, EPDM can be produced at such high molecular weight that the torque limit of the Mooney instrument can be exceeded using these standard prescribed rotors. In these instances, the test is run using the MST rotor that is both smaller in diameter and thinner. Typically, when the MST rotor is employed, the test is also run at different time constants and temperatures. The pre-heat time is changed from the standard 1 minute to 5 minutes, and the test is run at 200° C. instead of the standard 125° C. The value obtained under these modified conditions is referred to herein as MST (5+4@200° C.). Note: the run time of 4 minutes at the end of which the Mooney reading is taken remains the same as the standard conditions. One MST point is approximately equivalent to 5 ML points when MST is measured at (5+4@200° C.) and ML is measured at (1+4@125° C.). Accordingly, for the purposes of an approximate conversion between the two scales of measurement, the MST (5+4@200° C.) Mooney value is multiplied by 5 to obtain an approximate ML(1+4@125° C.) value equivalent. The MST rotor used herein was prepared and utilized according to the following specifications: The rotor should have a diameter of 30.48+/−0.03 mm and a thickness of 2.8+/−0.03 mm (determined from the tops of serrations) and a shaft of 11 mm or less in diameter. The rotor should have a serrated face and edge, with square grooves of about 0.8 mm width and depth of about 0.25-0.38 mm cut on 1.6 mm centers. The serrations will consist of two sets of grooves at right angles to each other thereby forming a square crosshatch. The rotor shall be positioned in the center of the die cavity such that the centerline of the rotor disk coincides with the centerline of the die cavity to within a tolerance of +/−0.25 mm. A spacer or a shim may be used to raise the shaft to the midpoint, consistent with practices typical in the art for Mooney determination. The wear point (cone shaped protuberance located at the center of the top face of the rotor) shall be machined off flat with the face of the rotor. Mooney viscosities of the multimodal polymer composition may be determined on blends of polymers herein. The Mooney viscosity of a particular component of the blend is obtained herein using the relationship shown in (1):

log ML=nA log MLA+nB log MLB (1)

wherein all logarithms are to the base 10; ML is the Mooney viscosity of a blend of two polymers A and B each having individual Mooney viscosities MLA and MLB, respectively; nA represents the wt % fraction of polymer A in the blend; and nB represents the wt % fraction of the polymer B in the blend.

In the instant disclosure, Equation (1) has been used to determine the Mooney viscosity of blends comprising a high Mooney viscosity polymer (A) and a low Mooney viscosity polymer (B), which have measurable Mooney viscosities under (1+4@125° C.) conditions. Knowing ML, MLA and nA, the value of MLB can be calculated.

However, for high Mooney viscosity polymers (i.e., Mooney viscosity greater than 100 ML(1+4@125° C.), MLA is measured using the MST rotor as described above. The Mooney viscosity of the low molecular weight polymer in the blend is then determined using Equation 1 above, wherein MLA is determined using the following correlation (2):

MLA(1+4@125° C.)=5.13*MSTA(5+4@200° C.) (2).

The polyolefin elastomeric copolymers of ethylene, propylene, and optionally, diene monomers, EPR or EPDM, may be prepared by traditional solution or slurry polymerization processes. In one or more embodiments, these copolymers are not prepared using the known gas-phase processes in order to avoid the necessity of pre-selection of filler, usually carbon black, by the rubber manufacturer. In one or more embodiments, the elastomer employed is substantially devoid of copolymer prepared by gas-phase processes. In certain embodiments, these copolymers are entirely excluded. In one or more embodiments, the copolymers include those of ethylene, propylene, and ethylidene norbornene and/or vinyl norbornene, and have a broad molecular weight distribution or polydispersity (MWD) of some Ziegler-Natta polymerization, e.g., 4-11, or narrow MWD of, for example 2-3, more typical of metallocene catalysts. Typically preferred catalysts for the copolymerization of the elastomers, or rubber, are the single site Ziegler-Natta catalysts, such as vanadium compounds, or the metallocene catalysts for Group 3-6 metallocene catalysts, particularly the bridged mono- or biscyclopentadienyl metallocenes.

In one or more embodiments, the elastomer, as it is introduced to the mixing device, is in a shredded, ground, granulate, crumb, or pelletized form. These various forms may be collectively referred to as elastomer particles. In these or other embodiments, the diameter of at least 50 weight %, in other embodiments at least 60 weight %, and in other embodiments at least 70 weight % of the elastomer particles as they are introduced to the mixing device is greater than 1.0 mm, in other embodiments greater than 2.0 mm, and in other embodiments greater than 3.0 mm. In these or other embodiments, the diameter of at least 50 weight %, in other embodiments at least 60 weight %, and in other embodiments at least 70 weight % of the pieces of the rubber as it is introduced to the mixing device is less than 30 mm, in other embodiments less than 20 mm, and in other embodiments less than 15 mm.

In one or more embodiments, the elastomer, as it is introduced to the mixing device, contains limited amounts or is devoid of carbon black. As is known, certain elastomers are in the form of small particulates coated with carbon black as a dusting agent, and it is the intent to limit or exclude this type of rubber. Accordingly, the elastomer, as it is introduced to the extruder, includes less than 10 parts by weight, in other embodiments less than 5 parts by weight, and in other embodiments less than 1 part by weight carbon black per 100 parts by weight elastomer. In particular embodiments, the elastomer is substantially devoid of carbon black, which refers to an amount less than that amount that would otherwise have an appreciable impact on the elastomer or process described herein. In certain embodiments, the elastomer is devoid of carbon black.

In one or more embodiments, the elastomer, before it is added to the mixing device used, may be oil-extended. This oil extension may derive from conventional methods of extending rubber such as where the oil is introduced to the rubber at the location where the rubber is manufactured. In other embodiments, the oil extension may derive from introducing oil to the elastomer prior to introducing the elastomer to the mixing device. In these or other embodiments, the oil may be introduced to the elastomer immediately prior to introducing the elastomer to the mixing device. Reference to oil extension or oil-extended rubber will refer to all forms of oil extension while excluding the addition of free oil to mixing device used in practicing this invention, which will be mixed with the elastomer.

In one or more embodiments, the elastomer may include limited oil extension. In these embodiments, the oil extension is less than 75 parts by weight, in other embodiments less than 70 parts by weight, in other embodiments less than 60 parts by weight, in other embodiments less than 50 parts by weight, in other embodiments less than 35 parts by weight, and in other embodiments less than 25 parts by weight oil per 100 parts by weight rubber. In these or other embodiments, the oil-extended rubber may include from about 0 to less than 75, in other embodiments from about 0 to about 50, and in other embodiments from about 0 to about 25 parts by weight oil per 100 parts by weight rubber. In particular embodiments, the rubber is non-oil extended. In other words, the rubber is devoid or substantially devoid of oil extension when it is introduced to the extruder.

### Plastic

In one or more embodiments, the thermoplastic polymer component includes a solid, generally high molecular weight polymeric plastic material, which may be referred to as a thermoplastic resin. This resin is a crystalline or a semi-crystalline polymer, and can be a resin that has a crystallinity of at least 25 percent as measured by differential scanning calorimetry. Polymers with a high glass transition temperature are also acceptable as the thermoplastic resin. In one or more embodiments, the melt temperature of these resins should be lower than the decomposition temperature of the rubber. Reference to a thermoplastic resin will include a thermoplastic resin or a mixture of two or more thermoplastic resins.

In one or more embodiments, the thermoplastic resins are crystallizable polyolefins that are formed by polymerizing α-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene or ethylene or propylene with another α-olefin such as 1-butene, 1-hexene, 1-octene, 2-methyl-1-propene, 3-methyl-1-pentene, 4-methyl-1-pentene, 5-methyl-1-hexene or mixtures thereof are also contemplated. These homopolymers and copolymers may be synthesized by using any polymerization technique known in the art such as, but not limited to, the “Phillips catalyzed reactions,” conventional Ziegler-Natta type polymerizations, and metallocene catalysis including, but not limited to, metallocene-alumoxane and metallocene-ionic activator catalysis. Suitable catalyst systems thus include chiral metallocene catalyst systems, see, e.g., U.S. Pat. No. 5,441,920, and transition metal-centered, heteroaryl ligand catalyst systems, see, e.g., U.S. Pat. No. 6,960,635.

In one or more embodiments, the thermoplastic resin is high-crystalline isotactic or syndiotactic polypropylene. These propylene polymers include both homopolymers of propylene, or copolymers with 0.1-30 wt. % of ethylene, or C₄-C₈ comonomers, and blends of such polypropylenes. The polypropylene generally has a density of from about 0.85 to about 0.91 g/cc, with the largely isotactic polypropylene having a density of from about 0.90 to about 0.91 g/cc. Also, high and ultra-high molecular weight polypropylene that has a low, or even fractional melt flow rate can be used.

The polyolefinic thermoplastic resins may have a M_{w} from about 200,000 to about 700,000, and a Mₙ from about 80,000 to about 200,000. These resins may have a M_{w} from about 300,000 to about 600,000, and a Mₙ from about 90,000 to about 150,000.

These polyolefinic thermoplastic resins may have a melt temperature (Tₘ) that is from about 150 to about 175° C., or from about 155 to about 170° C., or from about 160 to about 170° C. The glass transition temperature (T_{g}) of these resins is from about −5 to about 10° C., or from about −3 to about 5° C., or from about 0 to about 2° C. The crystallization temperature (T_{c}) of these resins is from about 95 to about 130° C., or from about 100 to about 120° C., or from about 105 to about 115° C. as measured by DSC and cooled at 10° C./min.

These thermoplastic resins generally can have a melt flow rate of up to 400 g/10 min, but the thermoplastic vulcanizates of the invention generally have better properties for many applications where the melt flow rate is less than about 30 g/10 min., preferably less than 10 g/10 min, or less than about 2 g/10 min, or less than about 0.8 g/10 min. Melt flow rate is a measure of how easily a polymer flows under standard pressure, and is measured by using ASTM D-1238 at 230° C. and 2.16 kg load.

In one or more embodiments, the thermoplastic polymers may be characterized by a heat of fusion (Hf), as determined by DSC procedures according to ASTM E 793, of at least 100 J/g, in other embodiments at least 180 J/g, in other embodiments at least 190 J/g, and in other embodiments at least 200 J/g.

Other exemplary thermoplastic resins, in addition to crystalline or semi-crystalline, or crystallizable, polyolefins, include, polyimides, polyesters(nylons), poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, and fluorine-containing thermoplastics. Molecular weights are generally equivalent to those of the polyolefin thermoplastics but melt temperatures can be much higher. Accordingly, the melt temperature of the thermoplastic resin chosen should not exceed the temperature at which the rubber will breakdown, that is when its molecular bonds begin to break or scission such that the molecular weight of the rubber begins to decrease.

### Curatives

Any curative agent that is capable of curing or crosslinking the elastomeric copolymer may be used. Some non-limiting examples of these curatives include phenolic resins, peroxides, maleimides, and silicon-containing curatives.

Any phenolic resin that is capable of crosslinking a rubber polymer can be employed in practicing the present invention. U.S. Pat. Nos. 2,972,600 and 3,287,440 are incorporated herein in this regard. The phenolic resin curatives can be referred to as resole resins and are made by condensation of alkyl substituted phenols or unsubstituted phenols with aldehydes, which can be formaldehydes, in an alkaline medium or by condensation of bi-functional phenoldialcohols. The alkyl substituents of the alkyl substituted phenols typically contain 1 to about 10 carbon atoms. Dimethylol phenols or phenolic resins, substituted in para-positions with alkyl groups containing 1 to about 10 carbon atoms can be used. These phenolic curatives are typically thermosetting resins and may be referred to as phenolic resin curatives or phenolic resins. These phenolic resins are ideally used in conjunction with a catalyst system. For example, non-halogenated phenol curing resins are used in conjunction with halogen donors and, optionally, a hydrogen halide scavenger. Where the phenolic curing resin is halogenated, a halogen donor is not required but the use of a hydrogen halide scavenger, such as ZnO, can be used. For a further discussion of phenolic resin curing of thermoplastic vulcanizates, reference can be made to U.S. Pat. No. 4,311,628, and U.S. Patent Application Serial No. 2004/017158 A1, both of which are incorporated by reference.

Peroxide curatives are generally selected from organic peroxides. Examples of organic peroxides include, but are not limited to, di-tert-butyl peroxide, dicumyl peroxide, t-butylcumyl peroxide, α,α-bis(tert-butylperoxy)diisopropyl benzene, 2,5 dimethyl 2,5-di(t-butylperoxy)hexane, 1,1-di(t-butylperoxy)-3,3,5-trimethyl cyclohexane, benzoyl peroxide, lauroyl peroxide, dilauroyl peroxide, 2,5-dimethyl-2,5-di(tert-butylperoxy)hexyne-3, and mixtures thereof. Also, diaryl peroxides, ketone peroxides, peroxydicarbonates, peroxyesters, dialkyl peroxides, hydroperoxides, peroxyketals and mixtures thereof may be used. Coagents such as triallylcyanurate are typically employed in combination with these peroxides. Coagent combinations may be employed as well. For example, combinations of high-vinyl polydienes and α-β-ethylenically unsaturated metal carboxylates are useful, as described in U.S. patent application Ser. No. 11/180,235, filed 13 Jul. 2005, which is incorporated herein by reference. Coagents may also be employed a neat liquids or together with a carrier. For example, the multi-functional acrylates or multi-functional methacrylates together with a carrier are useful, as disclosed in U.S. patent application Ser. No. 11/246,773, filed 7 Oct. 2005, which is also incorporated herein by reference. Also, the curative and/or coagent may be pre-mixed with the plastic prior to formulation of the thermoplastic vulcanizate, as described in U.S. Pat. No. 4,087,485, which is incorporated by reference. For a further discussion of peroxide curatives and their use for preparing thermoplastic vulcanizates, reference can be made to U.S. Pat. No. 5,656,693, which is incorporated herein by reference. When peroxide curatives are employed, the elastomeric copolymer may include 5-vinyl-2-norbornene and 5-ethylidene-2-norbornene as the diene component.

Useful silicon-containing curatives generally include silicon hydride compounds having at least two SiH groups. These compounds react with carbon-carbon double bonds of unsaturated polymers in the presence of a hydrosilylation catalyst. Silicon hydride compounds that are useful in practicing the present invention include, but are not limited to, methylhydrogen polysiloxanes, methylhydrogen dimethyl-siloxane copolymers, alkyl methyl polysiloxanes, bis(dimethylsilyl)alkanes, bis(dimethylsilyl)benzene, and mixtures thereof. An example of silicon hydride compounds is shown in U.S. Patent Application Serial No. 2004/017158 A1, which is incorporated by reference.

As noted above, hydrosilylation curing of the elastomeric polymer is conducted in the presence of a catalyst. These catalysts can include, but are not limited to, peroxide catalysts and catalysts including transition metals of Group VIII. These metals include, but are not limited to, palladium, rhodium, and platinum, as well as complexes of these metals. For a further discussion of the use of hydrosilylation to cure thermoplastic vulcanizates, reference can be made to U.S. Pat. Nos. 5,936,028 6,251,998, and 6,150,464, which are incorporated herein by reference. When silicon-containing curatives are employed, the elastomeric copolymer employed can include 5-vinyl-2-norbornene as the diene component.

Another useful cure system is disclosed in U.S. Pat. No. 6,277,916 B1, which is incorporated herein by reference. These cure systems employ polyfunctional compounds such as poly(sulfonyl azides).

### Oils

In one or more embodiments, the process oil employed, which may also be referred to as an extender oil or plasticizer, may include any oil employed in the art. Useful oils include mineral oils, synthetic processing oils, or combinations thereof may act as plasticizers in the compositions of the present invention. The plasticizers include, but are not limited to, aromatic, naphthenic, and extender oils. Exemplary synthetic processing oils include low molecular weight polylinear α-olefins, and polybranched α-olefins such as poly-alphα-olefins. Commercial examples include the SPECTRASYN® oils of ExxonMobil Chemical Co. Plasticizers from organic esters, alkyl ethers, or combinations thereof may also be employed. U.S. Pat. Nos. 5,290,886 and 5,397,832 are incorporated herein in this regard. Suitable esters include monomeric and oligomeric materials having an average molecular weight below about 2000, or below about 600. specific examples include aliphatic mono- or diesters or alternatively oligomeric aliphatic esters or alkyl ether esters. While certain embodiments of the present invention employ ester plasticizers, the processes of one or more embodiments employed are devoid or substantially devoid of the use of ester plasticizers.

### Processing Additives

In certain embodiments of this invention, the thermoplastic vulcanizate may also include one or more polymeric processing additives or property modifiers. One processing additive that can be employed is a polymeric resin that has a very high melt flow index. These polymeric resins include both linear and branched molecules that have a melt flow rate that is greater than about 500 g/10 min, or greater than about 750 g/10 min, or greater than about 1000 g/10 min, or greater than about 1200 g/10 min, or greater than about 1500 g/10 min. Melt flow rate is a measure of how easily a polymer flows under standard pressure, and is measured by using ASTM D-1238 at 230° C. and 2.16 kg load. The thermoplastic elastomers of the present invention may include mixtures of various branched or various linear polymeric processing additives, as well as mixtures of both linear and branched polymeric processing additives. Reference to polymeric processing additives will include both linear and branched additives unless otherwise specified. One type of linear polymeric processing additive is polypropylene homopolymers. One type of branched polymeric processing additive includes diene-modified polypropylene polymers. Thermoplastic vulcanizates that include similar processing additives are disclosed in U.S. Pat. No. 6,451,915, which is incorporated herein by reference.

Thermoplastic polymers which can be added for property modification include additional non-crosslinkable elastomers, including non-TPV thermoplastics, non-vulcanizable elastomers and thermoplastic elastomers. Examples include polyolefins such as polyethylene homopolymers and copolymers with one or more C₃-C₈ α-olefins. Specific examples include ethylene-propylene rubber (EPR), ULDPE, VLDPE, LLDPE, HDPE, and particularly those polyethylenes commonly known as “plastomers” which are metallocene catalyzed copolymers of ethylene and C₄-C₈ having a density of about 0.870 to 0.920. Propylene based elastomeric copolymers of propylene and 8-20 weight % of ethylene, and having a crystalline melt point (45-120° C.) are particularly useful with a polypropylene based thermoplastic phase, for example the random propylene copolymers sold under the name VISTAMAXX® by Exxon Mobil Chemical Co. Other thermoplastic elastomers having some compatibility with the principal thermoplastic or rubber, may be added such as the hydrogenated styrene, butadiene and or isoprene, styrene triblock copolymers (“SBC”), such as SEBS, SEPS, SEEPS, and the like. Non-hydrogenated SBC triblock polymers where there is a rubbery mid-block with thermoplastic end-blocks will serve as well, for instance, styrene-isoprene-styrene, styrene-butadiene-styrene, and styrene-(butadiene-styrene)-styrene.

### Other Additives

In addition to the thermoplastic resin, the vulcanizable elastomer, curatives, plasticizers, and any polymeric additive(s), the composition may also include reinforcing and non-reinforcing fillers, antioxidants, stabilizers, lubricants, antiblocking agents, anti-static agents, waxes, foaming agents, pigments, flame retardants and other processing aids known in the plastics or rubber compounding art. These additives can comprise up to about 50 weight percent of the total composition. Fillers and extenders that can be utilized include conventional inorganics such as calcium carbonate, clays, silica, talc, titanium dioxide, or organic, such as carbon black, as well as organic and inorganic nanosized, particulate fillers. The fillers, such as the carbon black, can be suitably added in combination with a carrier such as polypropylene. This invention provides the ability to add filler including those other than carbon black, together with the rubber as well as together with a thermoplastic carrier, such as polypropylene, in a single-pass or one-step process wherein all additions are added to one extruder, and well mixed prior to the exit of the melt processed thermoplastic vulcanizate from it.

### Amounts

Compositions of this invention can contain a sufficient amount of the vulcanized elastomeric copolymer to form rubbery compositions of matter. The skilled artisan will understand that rubbery compositions of matter are those that have ultimate elongations greater than 100 percent, and that quickly retract to 150 percent or less of their original length within about 10 minutes after being stretched to 200 percent of their original length and held at 200 percent of their original length for about 10 minutes.

Accordingly, the thermoplastic elastomers of the present invention may comprise at least about 10 percent by weight elastomeric copolymer, or at least about 35 percent by weight elastomeric copolymer, or at least about 45 percent by weight elastomeric copolymer, or at least about 50 percent by weight elastomeric copolymer. More specifically, the amount of elastomeric copolymer within the thermoplastic vulcanizate is generally from about 25 to about 90 percent by weight, or from about 45 to about 85 percent by weight, or from about 60 to about 80 percent by weight, based on the entire weight of the thermoplastic vulcanizate.

The thermoplastic elastomers can generally comprise from about 10 to about 80 percent by weight of the thermoplastic resin based on the total weight of the rubber and thermoplastic resin combined. The thermoplastic elastomers may comprise from about 10 to about 80 percent by weight, or from about 15 to about 60 percent by weight, or from about 20 to about 40 percent by weight, or from about 25 to about 35 percent by weight of the thermoplastic resin based on the total weight of the rubber and thermoplastic resin combined.

Where a phenolic resin curative is employed, a vulcanizing amount curative may comprise from about 1 to about 20 parts by weight, or from about 3 to about 16 parts by weight, or from about 4 to about 12 parts by weight, phenolic resin per 100 parts by weight rubber.

The skilled artisan will be able to readily determine a sufficient or effective amount of vulcanizing agent to be employed without undue calculation or experimentation. The amount of vulcanizing agent should be sufficient to at least partially vulcanize the elastomeric polymer, and the elastomeric polymer may be completely vulcanized.

Where a peroxide curative is employed, a vulcanizing amount of curative may comprise from about 1×10⁻⁴ moles to about 4×10⁻² moles, or from about 2×10⁻⁴ moles to about 3×10⁻² moles, or from about 7×10⁻⁴ moles to about 2×10⁻² moles per 100 parts by weight rubber.

Where silicon-containing curative is employed, a vulcanizing amount of curative may comprise from 0.1 to about 10 mole equivalents, or from about 0.5 to about 5 mole equivalents, of SiH per carbon-carbon double bond.

When employed, the thermoplastic elastomers may generally comprise from about 1 to about 25 percent by weight of the polymeric processing and property modifier additives based on the total weight of the rubber and thermoplastic resin combined. In one embodiment, the thermoplastic elastomers comprise from about 1.5 to about 20 percent by weight, or from about 2 to about 15 percent by weight of the polymeric processing additive based on the total weight of the rubber and thermoplastic resin combined.

Fillers, such as carbon black or clay, may be added in amount from about 10 to about 250 parts by weight, per 100 parts by weight of rubber. The amount of carbon black that can be used depends, at least in part, upon the type of carbon black and the amount of extender oil that is used.

### Method Description

Thermoplastic vulcanizates prepared by one or more embodiments of the present invention are prepared by dynamic vulcanization techniques. The term dynamic vulcanization refers to a vulcanization or curing process for a rubber blended with a thermoplastic resin, wherein the rubber is vulcanized under conditions of high shear mixing at a temperature above the melting point of the thermoplastic resin component. In one or more embodiments, the rubber is simultaneously crosslinked and dispersed as fine particles within the polyolefin matrix, although other morphologies may also exist.

Any melt processing equipment can be used in the process of the current invention. One or more pieces of processing equipment can be used, either in tandem or series. Examples of processing equipment include Buss-co kneader, planetary extruder, co- or counter rotating multi screw extruders, with two or more screw tips, co-rotating intermixing extruder with two or more screws, ring extruder or other polymer processing devices capable of mixing the oil, thermoplastic, cure agents, catalyst and can generate high enough temperature for cure can be used in the practice of current invention.

In one or more embodiments, dynamic vulcanization of the rubber takes place within a reaction extruder mixing device. These extruders and their use in the manufacture of thermoplastic vulcanizates are known in the art as exemplified in U.S. Pat. Nos. 4,594,390, 4,130,535, 4,311,628, 4,594,390, 6,147,160 and 6,042,260, as well as patent publications US 2006/0293457 A1 and WO 2004/009327 A1.

The term “screw tips” refers to the leading edge of the flights of the extruder screws. A twin screw extruder (TSE) of type 3 screw tips from Coperion Co., a ring extruder with 12 screw shafts arranged concentrically from Century, Inc. and, a mega-compounder from Coperion Co. may be used to illustrate the invention by examples noted. In each, the screws are intermeshing and co-rotating. In one embodiment, more than one melt-processor or extruder may be used, such as in a tandem arrangement. Preferably, melt-blending takes place with materials being in the melted or molten state.

In a continuous process, the materials may be mixed and melted in an extruder for dynamic curing, or mixed and melted in one extruder and passed to another extruder as a melt, or as a pellet if pelletized between extruders, for further dynamic curing. Also, the mixing of polymeric components with or without curing agents may be carried in one or more of melt compounders and then the curing is carried out in one or more extruders. Other arrangements and dynamic vulcanization processing equipment known to those skilled in the art may be used according to processing requirements. The processing may be controlled as described in U.S. Pat. No. 5,158,725 using process variable feedback.

In the dynamic vulcanization of thermoplastic elastomer blends, especially those blends containing a majority of elastomer, in the early stages of mixing, as the two ingredients are melted together, the lower temperature-melting elastomer comprises a continuous phase of a dispersion containing the thermoplastic polymer. As the thermoplastic melts, and the cross-linking of the elastomer takes place, the cured elastomer is gradually immersed into the molten thermoplastic polymer and eventually becomes a discontinuous phase, dispersed in a continuous phase of thermoplastic polymer. This is referred to as phase inversion, and if the phase inversion does not take place, the thermoplastic polymer may be trapped in the cross-linked elastomer network of the extruded vulcanizate such that the extrudate created will be unusable for fabricating a thermoplastic product. For temperature, viscosity control and improved mixing, the process oil is added at more than one (1) location along screw axis.

In one or more embodiments, the oil injection points into the extruder are positioned at or before one or more distributive mixing elements in the extruder, which distributive mixing element(s) is/are followed by one or more dispersive mixing elements. This arrangement particularly assists effective blending of the components for ease of processing and uniformity of the final extruded product. Additionally, it is particularly advantageous to add a liquid of oil diluted curative, or molten curative, through an injection port positioned in the same manner. The distributive element serves principally to effect homogeneous blending of one component with another and the dispersive mixing element serves principally to effect reduction in particle size of the dispersed phase material.

In particular embodiments, the extruder could have multiple barrels, with different temperature ranges for the different barrels. In one embodiment, the following mixing elements can be located after the addition of the process oil and/or curing agent: 3×ZME 15/30, KB60/3/30, and KB60/3/60. In these embodiments, two examples of suitable diameters of the extruder are 53 mm and 83 mm. In one embodiment, the following mixing elements may be located after the addition of the process oil: (1) ZME15/30, KB60/3/30, KB60/3/60, (2) ZME15/30, and 2×KB60/3/30. For the larger diameter extruders, the following three mixing element combinations can be located after the addition of the process oil: (1) KB30/5/60; (2) KB60/3/45 and KB60/3/90; and, (3) ZME20/40, KB30/5/30, and 2×KB60/3/45. In extruders of size greater than 83 mm diameter, the mixing elements can be scaled up from smaller to larger scale, proportional to their diameter ratio. These extruder mixing elements, and others, and their functions are described in a publication from Coperion Corporation entitled “Processing Lines”. vol. 9. No. 1, January 1999.

In one or more embodiments, the elastomer and at least a portion of the thermoplastic resin is introduced to the mixing device. This may occur at a feed hopper such as is conventional in the art. Following the addition of the elastomer and at least a portion of the thermoplastic resin, curative is added. Inasmuch as the curative can be added at more than one location within the extruder, and because the curative or cure system may include several components, reference to the location or introduction at which the curative is added refers to that point where the final component of the cure system is added to achieve the desired cure level.

According to one or more embodiments, oil is added to the extruder together with or before the location at which the curative is introduced. The oil added prior to the addition or together with the curative may be referred to as the upstream addition of oil. The oil added after the addition of the curative may be referred to as the downstream addition of the oil. Thus, the process of this invention includes both upstream and downstream addition of oil.

In one or more embodiments, the location at which the upstream addition of oil takes place may include any location within the extruder together with or after the initial introduction of elastomer up until and including the addition of the curative. In other words, the oil is added after the addition of the rubber, but prior to or together with the curative. In particular embodiments, the upstream addition of oil includes multiple introductions of oil. For example, the first introduction occurs after the introduction of rubber and before the introduction of curative. The second introduction of oil occurs together with the curative. In other embodiments, both introductions occur after introduction of the rubber but before introduction of the curative. In other embodiments, the upstream addition of oil occurs incrementally so that the oil can be gradually introduced to avoid slippage and surging within the mixing device.

In one or more embodiments, the upstream addition of oil occurs in a manner that the specific energy of the mixing, as measured by the ratio of total power use in kilowatts and extrusion rate in kg/hr, is relatively constant within a standard variation of less than 20%, in other embodiments less than 15%, and in other embodiments less than 10%. The stability of specific energy is an indicator of reduced slip in the extruder. Similarly, stable measurements in the extruder can also provide a measure of mixing stability. This can be accomplished by incremental addition of oil or through the selection of appropriate mixing design.

In one or more embodiments, the location at which the upstream addition of oil takes place may be defined with respect to the ratio of the length and diameter of the extruder. In other words, a particular location within the extruder can be defined as a particular L(length)/D(diameter) of the extruder from a particular location (e.g., curative addition or from the upstream edge of the barrel in which the elastomer addition takes place, which normally is at the feed throat). In particular embodiments, the location is defined with respect to the upstream edge of the barrel in which the curative addition takes place. In one or more embodiments, the upstream addition of oil occurs within 0 L/D, in other embodiments within 20 L/D, and in other embodiments within 30 L/D from the upstream edge of the barrel in which the curative is introduced to the extruder. In these or other embodiments, the upstream addition of oil may be introduced to the extruder within 25 L/D, in other embodiments within 20 L/D, and in other embodiments within 10 L/D from the upstream edge of the barrel in which the elastomer is introduced to the extruder (but at a location after introduction of the elastomer).

In one or more embodiments, the total amount of oil introduced upstream together with the oil introduced with the rubber (e.g., oil extension) is at least 50 parts by weight, in other embodiments at least 55 parts by weight, in other embodiments at least 60 parts by weight, in other embodiments at least 65 parts by weight, and in other embodiments at least 70 parts by weight oil per 100 parts by weight rubber. In these or other embodiments, the total amount of oil introduced upstream together with the oil introduced with the rubber (e.g., oil extension) is less than 110 parts by weight, in other embodiments less than 105 parts by weight, in other embodiments less than 100 parts by weight, in other embodiments less than 80 parts by weight, and in other embodiments less than 50 parts by weight oil per 100 parts by weight rubber. The quantity of plasticizer added depends upon the properties desired, with the upper limit depending upon the compatibility of the particular oil and blend ingredients; this limit is exceeded when excessive exuding of plasticizer occurs.

In these or other embodiments, the total amount of oil introduced upstream exclusive of any oil added together with the rubber (e.g., oil extension) is greater than 8 parts by weight, in other embodiments greater than 12 parts by weight, in other embodiments greater than 20 parts by weight, in other embodiments greater than 30 parts by weight oil per 100 parts by weight rubber. In these or other embodiments, the total amount of oil introduced upstream exclusive of any oil introduced with the rubber may be from about 10 to about 110, in other embodiments from about 30 to about 80, and in other embodiments from about 50 to about 95.

As noted above, the location at which the downstream oil takes place may include any location within the extruder after the introduction of curative. The location at which the downstream addition of oil takes place may be defined with respect to the ratio of the length and diameter of the extruder. In one or more embodiments, the downstream addition of oil occurs within 25 L/D, in other embodiments within 15 L/D, and in other embodiments within 10 L/D from the location at which the curative is introduced to the extruder (i.e., downstream of the location at which the curative is introduced).

In one or more embodiments, the amount of oil added downstream, exclusive of any other oil introduced to the extruder, is at least 5 parts by weight, in other embodiments at least 27 parts by weight, and in other embodiments at least 44 parts weight, and in other embodiments at least 80 parts by weight oil per 100 parts by weight rubber. In these or other embodiments, the oil added downstream, exclusive of any other oil added to the extruder, is less than 150 parts by weight, in other embodiments less than 100 parts by weight, in other embodiments less than 50 parts by weight, and in other embodiments less than 25 parts by weight oil per 100 parts by weight rubber.

In these or other embodiments, the total amount of oil added to the extruder downstream is such that the total amount of the oil introduced to the extruder (including oil extension and oil introduced upstream) is from about 25 to about 300 parts by weight, in other embodiments from about 50 to about 200 parts by weight, and in other embodiments from about 75 to about 150 parts by weight per 100 parts by weight rubber.

The process oil can be heated before introduction of the extruder. The amount of thermoplastic added in the initial melt blending step is at least that determined empirically sufficient to allow phase inversion, such that the initial blend becomes one of a continuous thermoplastic phase, and a discontinuous crosslinked rubber phase upon continued mixing with the addition of curing agent. The curing agent is typically added after effective blending has been achieved between the elastomer and thermoplastic resin and with continued melt mixing to permit the dynamic crosslinking of the rubber. Phase inversion then occurs as the crosslinking of the rubber continues. The additional filler, processing aids, polymeric modifiers, etc., can be added prior to the addition of curative and initiation of crosslinking where such does not interfere with the crosslinking reaction, or after the crosslinking reaction is nearly complete where such may interfere.

Additionally, while the presence of oil during the vulcanization of rubber can be deleterious when forming conventional thermoset rubber compositions, the current inventors have discovered that the presence of oil during cure, especially from the upstream addition of oil, leads to advantageous cure states in thermoplastic vulcanizates. It is believed that the presence of the oil permits more effective and uniform dispersion of the cross-linking, or curing agents with the rubber to be cured just prior to and during the dynamic curing reaction. Additional thermoplastic, and any other additives, can be added after crosslinking of the rubber is complete, or at least nearly so, to avoid unnecessary dilution of the active reactants.

Those ordinarily skilled in the art will appreciate the appropriate quantities, types of cure systems, and vulcanization conditions required to carry out the vulcanization of the rubber. The rubber can be vulcanized by using varying amounts of curative, varying temperatures, and a varying time of cure in order to obtain the optimum crosslinking desired. Because the conventional elastomeric copolymers are not granular and do not include inert material as part of the manufacturing or synthesis of the polymer, additional process steps can be included to granulate or add inert material, if desired, to the conventional elastomeric copolymer.

### Product Characteristics

Despite the fact that the rubber component is partially or fully cured, the compositions produced by this invention can be processed and reprocessed by conventional plastic processing techniques such as extrusion, injection molding, and compression molding. The rubber within these thermoplastic elastomers is usually in the form of finely-divided and well-dispersed particles of vulcanized or cured rubber, with well dispersed carbon black.

In one or more embodiments, the rubber can be highly cured. In one embodiment, the rubber is advantageously completely or fully cured. The degree of cure can be measured by determining the amount of rubber that is extractable from the thermoplastic vulcanizate by using cyclohexane or boiling xylene as an extractant. This method is disclosed in U.S. Pat. No. 4,311,628, which is incorporated herein by reference. In one or more embodiments, the rubber has a degree of cure where not more than 5.9 weight percent, in other embodiments not more than 5 weight percent, in other embodiments not more than 4 weight percent, and in other embodiments not more than 3 weight percent is extractable by cyclohexane at 23° C. as described in U.S. Pat. Nos. 5,100,947 and 5,157,081, which are incorporated herein by reference. In these or other embodiments, the rubber is cured to an extent where greater than 94%, in other embodiments greater than 95%, in other embodiments greater than 96%, and in other embodiments greater than 97% by weight of the rubber is insoluble in cyclohexane at 23° C. Alternatively, in one or more embodiments, the rubber has a degree of cure such that the crosslink density is preferably at least 4×10⁻⁵, in other embodiments at least 7×10⁻⁵, and in other embodiments at least 10×10⁻⁵ moles per milliliter of rubber. See also “Crosslink Densities and Phase Morphologies in Dynamically Vulcanized TPEs,” by Ellul et al., RUBBER CHEMISTRY AND TECHNOLOGY, Vol. 68, pp. 573-584 (1995).

Despite the fact that the rubber may be fully cured, the compositions of this invention can be processed and reprocessed by conventional plastic processing techniques such as extrusion, injection molding, blow molding, and compression molding. The rubber within these thermoplastic elastomers can be in the form of finely-divided and well-dispersed particles of vulcanized or cured rubber within a continuous thermoplastic phase or matrix. In other embodiments, a co-continuous morphology may exist. In those embodiments where the cured rubber is in the form of finely-divided and well-dispersed particles within the thermoplastic medium, the rubber particles can have an average diameter that is less than 50 μm, optionally less than 30 μm, optionally less than 10 μm, optionally less than 5 μm, and optionally less than 1 μm. In certain embodiments, at least 50%, optionally at least 60%, and optionally at least 75% of the particles have an average diameter of less than 5 μm, optionally less than 2 μm, and optionally less than 1 μm.

### Use

The thermoplastic elastomer of this invention is useful for making a variety of articles such as weather seals, hoses, belts, gaskets, moldings, boots, elastic fibers and like articles. They are useful for making articles by blow molding, extrusion, injection molding, thermo-forming, elastic-welding, compression molding techniques, and by extrusion foaming. More specifically, they are useful for making vehicle parts such as weather seals, brake parts such as cups, coupling disks, and diaphragm cups, boots such as constant velocity joints and rack and pinion joints, tubing, sealing gaskets, parts of hydraulically or pneumatically operated apparatus, o-rings, pistons, valves, valve seats, valve guides, and other elastomeric polymer based parts or elastomeric polymers combined with other materials such as metal/plastic combination materials. Also contemplated are transmission belts including V-belts, toothed belts with truncated ribs containing fabric faced V's, ground short fiber reinforced V's or molded gum with short fiber flocked V's. Foamed articles, such as weather seal extrudates for the construction and vehicle manufacture industries, and for liquid carrying hoses, e.g., underhood automotive, are also particularly well suited.

The invention having been described, working examples are presented below to further illustrate the invention. Though several embodiments are presented, it will be apparent to those skilled in the art that the illustrated methods may incorporate changes and modifications without departing from the general scope of this invention. The invention includes all such modifications and alterations in so far as they come within the scope of the appended claims or the equivalents thereof. Thus, the scope of the invention includes all modifications and variations that may fall within the scope of the claims.

In further embodiments, the present invention includes:
a) A method for preparing a thermoplastic vulcanizate, the method comprising:
   i. introducing an elastomer and a thermoplastic resin to a reaction extruder, where the elastomer is not prepared by gas-phase polymerization methods, and where less than 75 parts by weight oil, per 100 parts by weight elastomer, is added to the extruder with the elastomer;
   ii. introducing a curative to the extruder after said step of introducing an elastomer;
   iii. introducing an oil to the extruder after said step of introducing an elastomer but before or together with said step of introducing a curative; and
   iv. introducing an oil to the extruder after said step of introducing a curative.
b) The method of any of the preceding embodiments, where said step of introducing an oil after said step of introducing an elastomer includes introducing an oil to the extruder before said step of introducing a curative.
c) The method of any of the preceding embodiments, where said step of introducing an oil after said step of introducing an elastomer includes introducing an oil before and together with a curative.
d) The method of any of the preceding embodiments, where the total oil introduced to the extruder after said step of introducing an elastomer but before or together with said step of introducing a curative is greater than 8 parts by weight per 100 parts by weight elastomer.
e) The method of any of the preceding embodiments, where the total oil added to the extruder as oil extension and introduced to the extruder after said step of introducing an elastomer but before or together with said step of introducing a curative is at least 50 parts by weight per 100 parts by weight elastomer.
f) The method of any of the preceding embodiments, where the total oil added to the as oil extension and introduced to the extruder after said step of introducing an elastomer but before or together with said step of introducing a curative is at least 50 parts by weight per 100 parts by weight elastomer, and less than 131 parts by weight.
g) The method of any of the preceding embodiments, where the elastomer includes a polyolefin copolymer rubber having a weight average molecular weight of less than 850,000 g/mole and a number average molecular weight of less than 300,000 g/mole.
h) The method of any of the preceding embodiments, where the polyolefin copolymer rubber includes from about 0.1 to about 14 weight percent units deriving from 5-ethylidene-2-norbornene.
i) The method of any of the preceding embodiments, where said step of introducing an elastomer includes introducing elastomer particles, where at least 50% of the particles have a diameter greater than 1.0 mm.
j) The method of any of the preceding embodiments, where said step of introducing an elastomer includes introducing elastomer particles that are substantially devoid of carbon black or a carbon black coating.

In order to demonstrate the practice of the present invention, the following examples have been prepared and tested. The examples should not, however, be viewed as limiting the scope of the invention. The claims will serve to define the invention.

Further, with respect to all ranges described herein, any bottom range value may be combined with any upper range value to the extent such combination is not violative of a basic premise of the range described (i.e., lower and upper ranges of weight percents components are present in a composition may not be combined to the extent they would result in more than 100 weight percent in the overall composition).

### EXAMPLES

### Materials:

Thermoplastic vulcanizates were prepared by employing the recipes set froth in Table 2. The characteristics of the various ingredients are provided in Tables 1a and 1b.

TABLE 1a

| EPDM | | | | Manufacturer/ |
|---|---|---|---|---|
| Type | Product Name | MST | Chemical | Distributor |
| 1 | Vistalon ® 3666 | 50 | Ethylene-propylene-ethylidene norbornene | ExxonMobil |
| | | | (oil = 75 phr), Mooney (ML 1 + 4, 125° C.) = | Chemical Co. |
| | | | 52, 62 wt. % ethylene, 4.5 wt. % ENB | |
| 2 | Vistalon ® 8600 | 16 | Ethylene-propylene-ethylidene norbornene | ExxonMobil |
| | | | (oil = 0 phr), Mooney (ML 1 + 8, 125° C.) = | Chemical Co. |
| | | | 81, 58 wt. % ethylene, 8.9 wt. % ENB | |
| 3 | Exp. 1 | 25 | Ethylene-propylene-ethylidene norbornene | n/a |
| | | | (oil = 25 phr), Mooney (ML 1 + 4, 125° C.) = | |
| | | | 72, 63 wt. % ethylene, 3.0 wt. % ENB, M_{w} = | |
| | | | 314,000, M_{w}/Mn = 2.24 | |
| 4 | Exp. 2 | 25 | Ethylene-propylene-ethylidene norbornene | n/a |
| | | | (oil = 25 phr), Mooney (ML 1 + 4, 125° C.) = | |
| | | | 63, 63 wt. % ethylene, 4.5 wt. % ENB,, M_{w} = | |
| | | | 307,000, M_{w}/Mn = 2.47 | |
| 5 | Exp. 3 | 11 | Ethylene-propylene-ethylidene norbornene | n/a |
| | | | (oil = 0 phr), Mooney (ML 1 + 4, 125° C.) = | |
| | | | 50, 63 wt. % ethylene, 4.5 wt. % ENB, M_{w} = | |
| | | | 200,000, M_{w}/Mn = 2.82 | |
| 6 | Exp. 4 | 11 | Ethylene-propylene-ethylidene norbornene | n/a |
| | | | (oil = 0 phr), Mooney (ML 1 + 4, 125° C.) = | |
| | | | 51, 63 wt. % ethylene, 6.0 wt. % ENB,, M_{w} = | |
| | | | 202,000, M_{w}/Mn = 2.82 | |
| 7 | Exp. 5 | 11 | Ethylene-propylene-ethylidene norbornene | n/a |
| | | | (oil = 0 phr), Mooney (ML 1 + 4, 125° C.) = | |
| | | | 50, 64 wt. % ethylene, 4.5 wt. % ENB,, M_{w} = | |
| | | | 200,000, M_{w}/Mn = 2.92 | |

TABLE 1B

| | | | Manufacturer/ |
|---|---|---|---|
| Type | Product Name | Chemical | Distributor |
| PP 1 | D008M | Isotactic polypropylene homopolymer, MFR = | Sunoco |
| | | 0.8 | |
| PP 2 | FP230F | Isotactic polypropylene homopolymer, MFR = | Sunoco |
| | | 20 | |
| PP 3 | Lyondel 51S07A | Isotactic polypropylene homopolymer, MFR = | Lyondel (now |
| | | 0.7 | Sunoco) |
| Oil 1 | Sunpar 150M | Paraffinic Process Oil | RE Carol |
| Oil 2 | Sunpar 150 | Paraffinic Process Oil | RE Carol |
| Ester oil | Plasthall ® 100 | Aliphatic Ester Plasticizer | C.P. Hall |
| Curative 1 | HRJ-14247 | Phenolic Resin Curing Agent (oil dilution) | Schenectady Int |
| Curative 2 | SP 1045 | Phenolic Resin Curing Agent | Schenectady Int. |
| Zinc | Kadox911 | Zinc Oxide | Zinc Corp. Of |
| Oxide | | | America |
| Stannous | Stannous | Stannous Chloride | Mason Corp. |
| Chloride | Chloride | | |
| Wax 1 | Sunolite wax | Paraffinic wax | Astor |
| | 5240 | | |
| Black | AMPACET | Carbon black and polypropylene concentrate | Ampacet |
| | 49974 | | |

TABLE 2

| EPDM Type | 1 | 2a | 2b | 3 | 4 | 5 | 6 | 7 |
|---|---|---|---|---|---|---|---|---|
| Materials | phr | phr | phr | phr | phr | phr | phr | phr |
| EPDM¹ | 100 | 100 | 100 | 100 | 100 | 100 | 100 | 100 |
| EPDM Extension Oil | 75 | 0 | 0 | 25 | 25 | 0 | 0 | 0 |
| PP 1 | 46 | — | — | 46 | 46 | 46 | 46 | 46 |
| PP 2 | 6 | — | — | 6 | 6 | 6 | 6 | 6 |
| PP 3 | — | 59 | 59 | — | — | — | — | — |
| Process oil 1³ | 56 | — | — | 106 | 106 | 131 | 131 | 131 |
| Process oil 2³ | — | 107 | — | — | — | — | — | — |
| Plasticizer³ | — | — | 107 | — | — | — | — | — |
| Zinc Oxide | 2.0 | 2.0 | 2.0 | 2.0 | 2.0 | 2.0 | 2.0 | 2.0 |
| Curative 1² | 10.5 | — | — | 10.5 | 10.5 | 10.5 | 10.5 | 10.5 |
| Curative 2 | — | 7.0 | 7.0 | — | — | — | — | — |
| Stannous Chloride | 1.20 | 1.26 | 1.26 | 1.20 | 1.20 | 1.20 | 1.20 | 1.20 |
| Filler | 42 | 20 | 20 | 42 | 42 | 42 | 42 | 42 |
| Wax 1 | 3.5 | — | — | 3.5 | 3.5 | 3.5 | 3.5 | 3.5 |
| Black | — | 19.3 | 19.3 | — | — | — | — | — |

¹100 PHR was EPDM and some of these EPDMs had oil extension
²Includes carrier oil at 70 wt % (7.4 phr) and active curative 3.1 phr
³Process oil in phr added into the extruder during processing

### Process Description:

The following description explains the process employed in the following samples unless otherwise specified. A co-rotating, fully intermeshing type twin screw extruder, supplied by Coperion Corporation, Ramsey N.J., was used following a method similar to that described in U.S. Pat. No. 4,594,391 (excepting those altered conditions identified here). EPDM was fed into the feed throat of a ZSK 53 extruder of L/D (length of extruder over its diameter) of about 44. The thermoplastic resin was also fed into the feed throat along with other reaction rate control agents such as zinc oxide and stannous chloride. Filler, such as clay, was also added into the feed throat. Process oil was injected into the extruder at two different locations along the extruder. The curative was injected into the extruder after the rubber and thermoplastics commenced blending at about an L/D of 18.7, but after the introduction of first process oil at about an L/D of 6.5. In some examples, the curative was injected with the process oil, which oil may or may not have been the same as the other oil introduced to the extruder. The second process oil was injected into the extruder after the curative injection at about an L/D of 26.8. Rubber crosslinking reactions were initiated and controlled by balancing a combination of viscous heat generation due to application of shear, barrel temperature set point, use of catalysts, and residence time.

The extruded materials were fed into the extruder at a rate of 70 kg/hr and the extrusion mixing was carried out at 325 revolutions per minute (RPM), unless specified. A barrel metal temperature profile in ° C., starting from barrel section 2 down towards the die to barrel section 12 of 160/160/160/160/165/165/165/165/180/180/180/180 (wherein the last value is for the die) was used. Low molecular weight contaminants, reaction by-products, residual moisture and the like were removed by venting through one or more vent ports, typically under vacuum, as needed. The final product was filtered using a melt gear pump and a filter screen of desired mesh size. A screw design with several mixing sections including a combination of forward convey, neutral, left handed kneading blocks and left handed convey elements to mix the process oil, cure agents and provide sufficient residence time and shear for completing cure reaction, without slip or surging in the extruder, were used.

### Sample Analysis and Results Definitions:

The abbreviations and test methods used in this disclosure are explained below. Test specimens were molded at 190° C. for property testing:
“Hard” is the hardness of the TPV, measured in Sh A or Sh D units in accordance with ASTM D2240.
“M100” is the modulus of the material, and the M100 test indicates resistance to strain at 100% extension in force per unit area in accordance with ASTM D412 (ISO 37 type 2).
“UE %” is ultimate elongation, and indicates the distance a strand of the material can be stretched before it breaks in accordance with ASTM D412 (ISO 37 type 2).
“WtGn %” is a measurement of the amount of oil absorbed by the sample in an oil swell resistance test. Such a test is shown in U.S. Pat. No. 6,150,464. The test is based on ASTM D471 and ISO 1817, and requires a sample of TPV to be immersed in IRM 903 oil for 24 hours at 121° C. The weight gain percentage is a measure of the completeness of the cross-linking of the vulcanizate. Although weight gain values can vary depending on whether or not the elastomer is oil extended, and how much, in TPVs having the same composition, the values show the amount of cross-linking of the vulcanizates relative to each other.
“TnSet %” is the tension set, which is a measure of the permanent deformation of the TPV when it is stretched. A test specimen of dimensions 50.8 mm (2 in.) long, 2.54 mm (0.1 in.) wide and 2.03 mm (0.08 in.) thick, cut from an injection molded plaque is stretched to 100% and held for 10 minutes at 23° C. It is then allowed to relax at 23° C. for 10 minutes. The change in the length of the original specimen is measured and the TnSet % is calculated according to the formula:

TnSet %=((L₁−L₀)/L₀)×100, where L₀ is the original length and L₁ is the final length.
“Comset %” is the compression set, which is a measure of the permanent deformation of TPV when it is compressed. The test method is based on ISO 815:1991. A test specimen conforming to Type A requirements in ISO 815 with dimensions 29±0.5 mm diameter and 12.5±0.5 mm thickness are cut and stacked from and injection molded plaques, each of thickness 2.03 mm. The sample is compressed to 75% (for Sh A hardness<75) of its original height for 22 hrs at 100° C. The sample is then allowed to relax at 23° C. for about 30 minutes. The change in height of the original specimen is measured and the Comset % is calculated according to the formula:

Comset %=100×(Initial thickness−Final thickness)/Initial thickness−spacer thickness minus thickness of shims and/or foils)
“ESR” is a measure of the surface smoothness of the TPV in micro inches, where lower numbers indicate a more smooth surface. The ESR was measured using a Surfanalizer, supplied by Federal, in accordance with the manufacturer's instructions
“UTS” is the ultimate tensile strength, and is given is force per unit area in accordance with ASTM D412 (ISO 37 type 2).
“LCR” is a measurement of viscosity in Pa-sec at 1200 sec⁻¹ shear rate using Lab Capillary Rheometer from Dynisco, per method described in ASTM D 3835.
“SpE” is the specific energy of the extrusion process in KW-Hr/Kg, and is a measure of the processing efficiency. SpE is measured by dividing the total motor power in KW, consumed by the extruder with the production rate in Kg/hr.
“Ext %.” is the weight % extractable measured after 48 hrs at room temperature in cyclohexane solvent. “Lower Ext.” means higher state of cure or crosslink density in the elastomer. It is a measure of uncured weight % elastomer. Percent of crosslinked elastomer can be calculated by subtracting the extractable weight from 100.
“Extvis” is extensional viscosity 180° C., measured using Rheotens.
“Upstream oil” is process oil in phr, added during dynamic vulcanization into the extruder at a location prior to and/or with the addition of cure agent.
“Downstream oil” is process oil in phr added into the extruder after the addition of cure agent.
“Cure melt” is a polymer melt temperature in degrees centigrade measured using a melt thermocouple inserted into the barrel after the cure addition and before the addition of process oil.
Melt Flow rate (MFR), was measured according to the ASTM D-1238, 2.16 kg weight @ 230° C.
Notched Izod Impact was measured at −40° C. according to ASTM D256.
The toughness was the integrated area under the stress vs. strain curve determined according to ASTM D-412 at 23° C. by using an Instron testing machine.
Tg was determined from the temperature corresponding to the peak of tangent delta (ratio of elastic and loss moduli) measured from a temperature sweep at 0.1 Hz and 10 Hz respectively, by the Rheometrics® RDA-II instrument
MST measured at (5+4) at 200° C.
Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

### Examples C1-C6 and 1-18 (See Tables 3a and 3b)

In these Examples, the effect of the amount of oil added before the addition of curative on the thermoplastic vulcanizate properties using different EPDMs listed in Table 1, were explored in a twin-screw extruder. The amount of upstream oil, in phr, was varied from 7.4 to 49.4 with EPDM 1, 7.4 to 86.4 with EPDMs 3 and 4, and 7.4 to 111.4 with EPDMs 5-7. In all these examples, the total amount of process oil, including the amount of oil extension from the EPDM manufacturing process, was held constant at 138.4 phr. Formulations described in Table 2 by each of the EPDM Type was used in the producing the examples listed in Tables 3a and 3b. The results showed that at least 8 phr of pre cure process oil addition (i.e., upstream) was needed for lower WGn (%), lower sp.E (kw-hr/kg), and UTS (MPa). EPDMs containing lower or no oil extension required a higher amount of upstream process oil addition for improved properties. By combining the oil extension and the upstream process oil level, it was found that at least 33.4 phr of upstream process oil content was needed for improved cure and other properties.

TABLE 3a

| Example | C1 | 1 | 2 | 3 | C2 | 4 | 5 | 6 | C3 | 7 | 8 | 9 |
|---|---|---|---|---|---|---|---|---|---|---|---|---|
| EPDM type | 1 | 1 | 1 | 1 | 3 | 3 | 3 | 3 | 4 | 4 | 4 | 4 |
| Ext oil, phr | 75 | 75 | 75 | 75 | 25 | 25 | 25 | 25 | 25 | 25 | 25 | 25 |
| Upstream oïl phr | 7.4 | 21.4 | 35.4 | 49.4 | 7.4 | 33.4 | 69.4 | 86.4 | 7.4 | 33.4 | 69.4 | 86.4 |
| Downstream oïl phr | 56 | 42 | 28 | 14 | 106 | 80 | 44 | 27 | 106 | 80 | 44 | 27 |
| Hard, ShA | 69 | 68 | 70 | 69 | 67 | 68 | 66 | 66 | 64 | 65 | 65 | 64 |
| WGn., wt % | 105 | 98 | 87 | 89 | 100 | 98 | 97 | 105 | 141 | 93 | 84 | 92 |
| M100, MPa | 2.31 | 2.25 | 2.59 | 2.51 | 2.35 | 2.18 | 2.36 | 2.10 | 1.92 | 2.26 | 2.16 | 2.12 |
| UE, % | 425 | 446 | 504 | 457 | 321 | 381 | 473 | 305 | 304 | 335 | 445 | 479 |
| UTS, MPa | 5.00 | 5.40 | 6.78 | 5.94 | 4.72 | 4.72 | 6.27 | 6.22 | 2.92 | 4.74 | 5.94 | 6.22 |
| LCR, Pa-s | 79.6 | 81.7 | 81.5 | 77.5 | 75.3 | 82.8 | 75.3 | 78.1 | 71.9 | 77.1 | 77.9 | 79.9 |
| SpE, kw-h/kg | 0.41 | 0.39 | 0.34 | 0.34 | 0.40 | 0.36 | 0.32 | 0.32 | 0.42 | 0.37 | 0.30 | 0.30 |
| Cure melt, ° C. | 258 | 251 | 240 | 228 | 261 | 250 | 231 | 215 | 263 | 256 | 231 | 213 |

TABLE 3b

| Run No | C4 | 10 | 11 | 12 | C5 | 13 | 14 | 15 | C6 | 16 | 17 | 18 |
|---|---|---|---|---|---|---|---|---|---|---|---|---|
| EPDM Type | 5 | 5 | 5 | 5 | 6 | 6 | 6 | 6 | 7 | 7 | 7 | 7 |
| Ext oil, phr | 0 | 0 | 0 | 0 | 0 | 0 | 0 | 0 | 0 | 0 | 0 | 0 |
| Upstream oïl, phr | 43.4 | 58.4 | 94.4 | 111.4 | 42.4 | 76.4 | 94.4 | 111.4 | 42.4 | 76.4 | 94.4 | 111.4 |
| Downstream oïl phr | 95 | 80 | 44 | 27 | 96 | 62 | 44 | 27 | 96 | 62 | 44 | 27 |
| Hard, ShA | 61 | 63 | 63 | 63 | 60 | 69 | 63 | 62 | 62 | 64 | 63 | 63 |
| WGn., wt % | 116 | 100 | 98 | 98 | 129 | 99 | 98 | 110 | 110 | 94 | 90 | 99 |
| M100, MPa | 1.76 | 1.94 | 1.87 | 1.88 | 1.75 | 2.32 | 2.13 | 1.94 | 1.95 | 2.03 | 2.23 | 1.90 |
| UE % | 271 | 316 | 410 | 449 | 256 | 459 | 326 | 410 | 258 | 363 | 364 | 398 |
| UTS, MPa | 2.93 | 3.88 | 4.86 | 5.00 | 2.50 | 5.27 | 4.28 | 4.57 | 2.64 | 4.80 | 4.86 | 4.82 |
| LCR, Pa-s | 67.9 | 70.8 | 71.8 | 62.9 | 69.3 | 63.4 | 67.2 | 78.3 | 64.0 | 67.6 | 69.9 | 70.6 |
| SpE, kw-h/kg | 0.33 | 0.31 | 0.25 | 0.21 | 0.34 | 0.29 | 0.24 | 0.20 | 0.32 | 0.29 | 0.26 | 0.23 |
| Cure melt, ° C. | 250 | 242 | 210 | 197 | 247 | 237 | 212 | 227 | 259 | 243 | 221 | 209 |

### Examples 19-42 (See Tables 4a and 4b)

Tables 4a and 4b show examples at formulation and process conditions different from that described in Table 2 for EPDMs 3-7. Tables 4a and 4b show some of the differences. In some examples the curative level is higher (14 phr instead of 10.5). In some examples the amount of downstream oil level (hence overall oil level) was increased. In these examples, the downstream oil level increase also consisted of an increase in amount of PP 1 by 5 phr. In other examples (examples 39-42), only the PP phr was increased by 5 phr. This data showed that when the level of curing agent was increased, the WGn, % decreased and UTS increased.

By selecting a formulation at a higher level of curative or PP or process oil or a combination of these variables, TPVs with a balance of elastic, mechanical, and LCR Viscosity properties can be produced using lower molecular weight EPDMs with lower or no oil extension.

Tables 4a and 4b also show Compset % and Ext % values for limited samples. The Compset % values were higher at lower crosslinking agent level. Examples 38-42 were produced at a higher PP 1 phr level. Examples 22, 26, 30, 34, and 38 were prepared at an extrusion rate of 90 Kg/Hr and a screw speed of 350 RPM also showed technologically useful TPV properties.

TABLE 4a

| Run No | 19 | 20 | 21 | 22 | 23 | 24 | 25 | 26 | 27 | 28 | 29 | 30 |
|---|---|---|---|---|---|---|---|---|---|---|---|---|
| EPDM type | 3 | 3 | 3 | 3 | 4 | 4 | 4 | 4 | 5 | 5 | 5 | 5 |
| Curative 1, phr¹ | 14.0 | 10.5 | 14.0 | 10.5 | 14.0 | 10.5 | 14.0 | 10.5 | 14.0 | 10.5 | 14.0 | 10.5 |
| Upstream oil, phr | 71.9 | 69.4 | 71.9 | 69.4 | 71.9 | 69.4 | 71.9 | 69.4 | 96.9 | 94.4 | 96.9 | 94.4 |
| Downstream oil, phr | 41 | 59 | 56 | 44 | 41 | 59 | 56 | 44 | 41 | 59 | 56 | 44 |
| PP 1, phr | 46 | 51 | 51 | 46 | 46 | 51 | 51 | 46 | 46 | 51 | 51 | 46 |
| Hard, ShA | 67 | 66 | 69 | 66 | 66 | 66 | 66 | 66 | 64 | 63 | 64 | 63 |
| WGn., wt % | 80 | 89 | 83 | 87 | 79 | 88 | 76 | 81 | 86 | 89 | 79 | 91 |
| M100, MPa | 2.31 | 2.26 | 2.19 | 2.22 | 2.21 | 2.09 | 2.23 | 2.19 | 2.17 | 2.02 | 2.19 | 2.03 |
| Comset % | 29 | 38 | 31 | — | 27 | — | — | — | 32 | 42 | — | — |
| Ext % | 2.2 | — | — | — | — | — | — | — | 3.2 | — | — | — |
| UE, % | 474 | 410 | 407 | 438 | 406 | 403 | 371 | 466 | 376 | 415 | 381 | 382 |
| UTS, MPa | 6.74 | 5.35 | 5.34 | 5.85 | 6.12 | 5.21 | 5.46 | 5.92 | 5.61 | 5.06 | 5.39 | 4.58 |
| LCR, Pa-s | 88.6 | 74.7 | 76.4 | 78.1 | 80.0 | 76.9 | 73.8 | 72.6 | 74.0 | 65.4 | 63.7 | 68.5 |
| SpE, kw-h/kg | — | 0.32 | 0.33 | 0.31 | 0.32 | 0.31 | 0.31 | 0.27 | 0.26 | 0.24 | 0.25 | 0.20 |
| Cure melt, ° C. | — | 222 | 229 | 224 | 213 | 220 | 223 | 214 | 200 | 208 | 209 | 201 |

¹Includes oil in phr added with the curative.

TABLE 4b

| Run No | 31 | 32 | 33 | 34 | 35 | 36 | 37 | 38 | 39 | 40 | 41 | 42 |
|---|---|---|---|---|---|---|---|---|---|---|---|---|
| EPDM Type | 6 | 6 | 6 | 6 | 7 | 7 | 7 | 7 | 4 | 5 | 6 | 7 |
| Curative 1, PHR¹ | 14.0 | 10.5 | 14.0 | 10.5 | 14.0 | 10.5 | 14.0 | 10.5 | 10.5 | 10.5 | 10.5 | 10.5 |
| Upstream oil, phr | 96.9 | 94.4 | 96.9 | 94.4 | 96.9 | 94.4 | 96.9 | 94.4 | 69.4 | 69.4 | 69.4 | 69.4 |
| Downstream oil, phr | 41 | 59 | 56 | 44 | 41 | 59 | 56 | 44 | 44 | 44 | 44 | 44 |
| PP 1, PHR | 46 | 51 | 51 | 46 | 46 | 51 | 51 | 46 | 51 | 51 | 51 | 51 |
| Hard, ShA | 62 | 63 | 64 | 63 | 63 | 63 | 64 | 63 | 68 | 66 | 67 | 66 |
| WGn., wt % | 93 | 95 | 87 | 96 | 88 | 87 | 77 | 95 | 89 | 92 | 89 | 88 |
| M100, MPa | 9.66 | 2.04 | 2.13 | 2.35 | 2.07 | 1.98 | 2.08 | 1.85 | 2.33 | 2.34 | 2.30 | 2.13 |
| Comset % | 29 | — | — | — | — | — | — | — | — | — | — | — |
| UE % | 365 | 368 | 340 | 328 | 377 | 358 | 372 | 377 | 476 | 423/ | 357 | 381 |
| UTS, MPa | 5.35 | 4.58 | 4.82 | 4.81 | 4.27 | 5.16 | 5.47 | 4.33 | 6.07 | 5.21 | 5.13 | 5.36 |
| LCR, Pa-s | 74.9 | 63.6 | 65.3 | 68.8 | 83.0 | 64.9 | 67.7 | 70.3 | 78.3 | 69.5 | 69.6 | 68.3 |
| SpE, kw-h/kg | 0.25 | 0.23 | 0.24 | — | 0.28 | 0.26 | 0.26 | 0.22 | 0.32 | 0.25 | 0.25 | 0.26 |
| Cure melt, ° C. | 202 | 214 | 211 | — | 216 | 220 | 216 | 209 | 218 | 209 | 212 | 218 |

¹Includes oil in phr added with the curative.

### Examples C7-C8 and 43-48 (See Table 5)

Example TPVs shown Tables 5 were produced using the EPDM Type 2 and either paraffinic (oil 2) or ester plasticizer (ester oil). In these examples, the effect of the amount of process oil addition before cure was investigated. The results (compare C7 with 43-45 and C8 with 46-48) showed that upstream addition level of at least 27 phr was advantageous for a lower WGn (wt %), lower TnSet %, lower Comset %, lower UE %, higher UTS, and M100 (MPa).

### Examples C9-C10 and 49-54 (See Table 6)

Examples in Table 6 were produced using a twin screw extruder by melt blending the examples from Table 5 as the feed stock (FS) with additional PP. The results showed that the use of FS resulted in a composition with improved cure and physical properties at about 40 shore D hardness. Also, the notched Izod impact at −40° C. was improved when ester plasticizer oil was used instead of paraffin oil.

TABLE 5

| Examples | C7 | 43 | 44 | 45 | C8 | 46 | 47 | 48 |
|---|---|---|---|---|---|---|---|---|
| EPDM Type | 2 | 2 | 2 | 2 | 2 | 2 | 2 | 2 |
| Oil type | Oil 2 | Oil 2 | Oil 2 | Oil 2 | Ester oil | Ester oil | Ester oil | Ester oil |
| Ext oil, phr | 0 | 0 | 0 | 0 | 0 | 0 | 0 | 0 |
| Upstream oil, phr | 27 | 54 | 80 | 107 | 27 | 54 | 80 | 107 |
| Downstream oil, phr | 80 | 53 | 27 | 0 | 80 | 53 | 27 | 0 |
| Extvis, MPa-s | — | 0.17 | — | 0.35 | 0.0782 | 0.136 | 0.336 | — |
| Tg (S150 phase, ° C. @ 0.1 Hz) Rubber | −53.6 | −53.2 | −53.5 | −53.8 | −83.1 | −78.4 | −82.9 | −82.8 |
| Tg(S150 phase, ° C. @ 0.1 Hz) Polypropylene | −19.6 | — | −19.3 | −18.9 | −33.7 | −36.4 | −34.1 | −32.0 |
| Tg, Rubber - S150 phase, ° C. @ 10 Hz | −48.9 | −48.5 | −48.4 | −48.5 | −73.0 | −73.1 | −72.7 | −73.4 |
| Tg, Polypropylene - S150 phase, ° C. @ 10 Hz | −9.0 | — | — | −9.3 | −29.5 | — | −29.5 | −33.9 |
| Hard, ShA | 78 | 77 | 78 | 79 | 77 | 75 | 75 | 75 |
| M100, MPa | 3.12 | 3.63 | 4.00 | 4.10 | 2.69 | 2.93 | 3.44 | 3.32 |
| UTS, MPa | 4.70 | 8.00 | 8.70 | 9.51 | 4.02 | 5.82 | 8.68 | 7.95 |
| UE, % | 532 | 364 | 418 | 359 | 487 | 435 | 439 | 438 |
| Tough, MPa | 20.3 | 17.7 | 23.8 | 19.8 | 15.52 | 17 | 22.49 | 20.96 |
| Tnset, % | 38 | 18 | 20 | 15 | 35 | 20 | 15 | 15 |
| Comset % | 75 | 49 | 50 | 47 | 78 | 60 | 44 | 46 |
| WGn, wt % | 156 | 105 | 104 | 93 | 153 | 131 | 92 | 102 |

TABLE 6

| Examples | C9 | 49 | 50 | 51 | C10 | 52 | 53 | 54 |
|---|---|---|---|---|---|---|---|---|
| FS type | C7 | 43 | 45 | 46 | C8 | 46 | 47 | 48 |
| PP 3, phr | 160 | 160 | 160 | 160 | 160 | 160 | 160 | 160 |
| FS Upstream, phr | 27 | 54 | 50 | 107 | 27 | 54 | 80 | 107 |
| Extvis, MPa-s | 0.385 | 0.414 | 0.469 | 0.544 | 0.297 | 0.322 | 0.419 | 0.399 |
| Rheology, RDAII at 0.1 Hz | | | | | | | | |
| Tg, Rubber - P100 phase, ° C. | −58.6 | −54.1 | −53.5 | −53.5 | −83.1 | −83.1 | −77.7 | −77.8 |
| Tg, Polypropylene - P100 phase, ° C. | −14.1 | −14.1 | −14.4 | −14.3 | −29.4 | −31.6 | — | −28.8 |
| Rheology, RDAII at 1 Hz | | | | | | | | |
| Tg, Rubber - P100 phase, ° C. | −53.5 | −53.8 | −53.6 | −53.8 | — | — | — | — |
| Tg, Polypropylene - P100 phase, ° C. | −9.0 | −9.1 | −8.7 | −9.2 | — | — | — | — |
| Rheology, RDAII at 10 Hz | | | | | | | | |
| Tg, Rubber - P100 phase, ° C. | −49.0 | −48.8 | −48.8 | −48.5 | — | — | — | — |
| Tg, Polypropylene - P100 phase, ° C. | −3.9 | −4.0 | −4.0 | −4.0 | — | — | — | — |
| Notched Izod Impact at −40 C., J/m | 99 +/− 5 | 121 +/− 11 | 112 +/− 7 | 116 +/− 9 | 871 +/− 21 | 900 +/− 16 | 833 +/− 19 | 806 +/− 22 |
| Break Status, CB = complete break | CB | CB | CB | CB | NACB ¼″ | NACB ¼″ | NACB ¼″ | NACB ¼″ |
| Hard, ShD | 42 | 41 | 41 | 414 | 39 | 39 | 40 | 38 |
| M100, MPa | 9.76 | 10.29 | 10.46 | 10.74 | 9.52 | 9.89 | 9.95 | 10.41 |
| UTS, MPa | 16.51 | 18.43 | 22.61 | 21.44 | 14.21 | 15.88 | 18.9 | 19.9 |
| UE, % | 720 | 525 | 541 | 500 | 621 | 633 | 560 | 527 |
| Tough, MPa | 85.9 | 66.22 | 74.66 | 68.06 | 68.86 | 75.81 | 70.28 | 68.52 |
| Tnset, % | 56 | 42 | 41 | 44 | 50 | 47 | 43 | 40 |
| Comset % | 81 | 72 | 71 | 75 | 79 | 78 | 71 | 75 |
| WGn, wt % | 71.4 | 55.4 | 51.5 | 54.0 | 61 | 61 | 54 | 55 |

Various modifications and alterations that do not depart from the scope and spirit of this invention will become apparent to those skilled in the art. This invention is not to be duly limited to the illustrative embodiments set forth herein.

1. A method for preparing a thermoplastic vulcanizate, the method comprising:
i. introducing an elastomer and a thermoplastic resin to a reaction extruder, where the elastomer is not prepared by gas-phase polymerization methods, and where less than 75 parts by weight oil, per 100 parts by weight elastomer, is added to the extruder with the elastomer;
ii. introducing a curative to the extruder after said step of introducing an elastomer;
iii. introducing an oil to the extruder after said step of introducing an elastomer but before or together with said step of introducing a curative; and
iv. introducing an oil to the extruder after said step of introducing a curative.

2. The method of claim 1, where said step of introducing an oil after said step of introducing an elastomer includes introducing an oil to the extruder before said step of introducing a curative.

3. The method of claim 1, where said step of introducing an oil after said step of introducing an elastomer includes introducing an oil before and together with a curative.

4. The method of claim 1, where the total oil introduced to the extruder after said step of introducing an elastomer but before or together with said step of introducing a curative is greater than 8 parts by weight per 100 parts by weight elastomer.

5. The method of claim 1, where the total oil added to the extruder as oil extension and introduced to the extruder after said step of introducing an elastomer but before or together with said step of introducing a curative is at least 50 parts by weight per 100 parts by weight elastomer.

6. The method of claim 1, where the total oil added to the as oil extension and introduced to the extruder after said step of introducing an elastomer but before or together with said step of introducing a curative is at least 50 parts by weight per 100 parts by weight elastomer, and less than 131 parts by weight.

7. The method of claim 1, where the elastomer includes a polyolefin copolymer rubber having a weight average molecular weight of less than 850,000 g/mole and a number average molecular weight of less than 300,000 g/mole.

8. The method of claim 1, where the polyolefin copolymer rubber includes from about 0.1 to about 14 weight percent units deriving from 5-ethylidene-2-norbornene.

9. The method of claim 1, where said step of introducing an elastomer includes introducing elastomer particles, where at least 50% of the particles have a diameter greater than 1.0 mm.

10. The method of claim 1, where said step of introducing an elastomer includes introducing elastomer particles that are substantially devoid of carbon black or a carbon black coating.
